(19) United States
(12) Patent Application Publication
(10) Pub. No.: US 2017/0251292 A1
(43) Pub. Date: Aug. 31, 2017

(54) Audio Device With Acoustic Valve

(71) Applicant: Knowles Electronics, LLC, Itasca, IL (US)

(72) Inventor: Erik Wiederholtz, St. Charles, IL (US)

(21) Appl. No.: 15/055,184

(22) Filed: Feb. 26, 2016

(51) Int. Cl. H04R 1/10

(52) U.S. Cl. CPC H04R 1/1016; H04R 1/1041; H04R 2460/11

(57) ABSTRACT

In accordance with one aspect, an in-the-ear component of an audio device is provided that includes a receiver operable to produce sound, an ear canal-engaging portion, and an outer portion. The in-the-ear component further includes a passage extending through the ear canal-engaging portion and the outer portion and an acoustic valve operable to open and close the passage.

### TECHNICAL FIELD

This invention relates generally to audio devices and, more particularly, to audio devices for providing different modes of operation of the audio devices.

### BACKGROUND

In-the-ear components of audio devices, such as those used in hearing aids or other hearables, may be configured to create a full acoustic seal within the ear to maximize the acoustic performance of one or more receivers of the device such as for listening to music. This seal can cause occlusion, which is the feeling of pressure build up in one's ear and/or the perception of one's own voice as being excessively loud. Conversely, some devices are permanently vented which limits occlusion and allows ambient sounds pass through but, for some environments, may not provide optimized acoustic low frequency performance of the one or more receivers of the earphones.

### BRIEF DESCRIPTION OF THE FIGURES

For a more complete understanding of the disclosure, reference should be made to the following detailed description and accompanying drawings wherein:

FIG. 1 is a cross-sectional schematic view of an in-the-ear component of an audio device having a receiver and an acoustic valve;

FIG. 1A is an enlarged view of the area within the dashed circle of FIG. 1 showing the acoustic valve in an open configuration;

FIG. 2 is a cross-sectional view similar to FIG. 1A showing the acoustic valve in a closed configuration;

FIG. 3 is a cross-sectional view similar to FIG. 1A showing the acoustic valve being switched between open and closed configurations;

FIG. 4 is a cross-sectional view similar to FIG. 1 showing the acoustic valve being switched between closed and open configurations;

FIG. 5A is a cross-sectional schematic view of another acoustic valve showing the acoustic valve in a closed configuration;

FIG. 5B is a view similar to FIG. 5A showing the acoustic valve in an open configuration;

FIG. 6A is a cross-sectional schematic view of another acoustic valve showing the acoustic valve in an open configuration; and

FIG. 6B is a view similar to FIG. 6A showing the acoustic valve in a closed configuration.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. Elements in alternate embodiments are given three digit reference numbers with the first digit representing the embodiment, and the last two digits identifying corresponding parts found in both embodiments. For example, coil 112 in the first embodiment is substantially similar to coil 212 in the second embodiment and thus much of the description is not repeated.

### DETAILED DESCRIPTION

In accordance with one aspect of the present disclosure, an acoustic device such as a hearing aid is provided that includes a receiver operable to produce sound, an ear canal- engaging portion, and an outer portion. A receiver can be any device that converts electrical signals to sound, including speakers and transducers. In some embodiments, a receiver could also be an opening or chamber connected by an acoustic pathway to a sound source outside of the in-the-ear component. The in-the-ear component further includes a passage extending through the ear canal-engaging portion and the outer portion and an acoustic valve operable to open and close the passage. When the acoustic valve is open, the pressure within the air canal can equalize which limits occlusion experienced by a user. The open acoustic valve also allows ambient sound to travel through the sound passage and into the ear canal. When the acoustic valve is closed, the ear canal-engaging portion may create a full acoustic seal with the user's ear which may be preferable for certain activities, such as listening to music. Also provided is a method of quickly and efficiently opening and closing the acoustic valve with an electrical pulse.

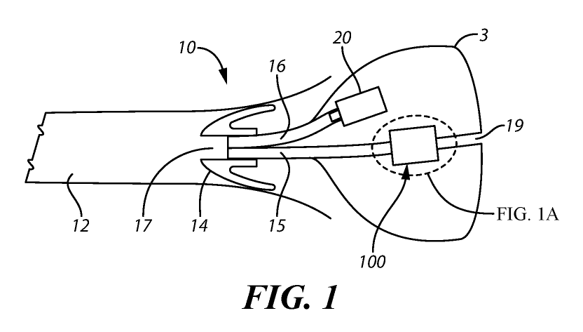

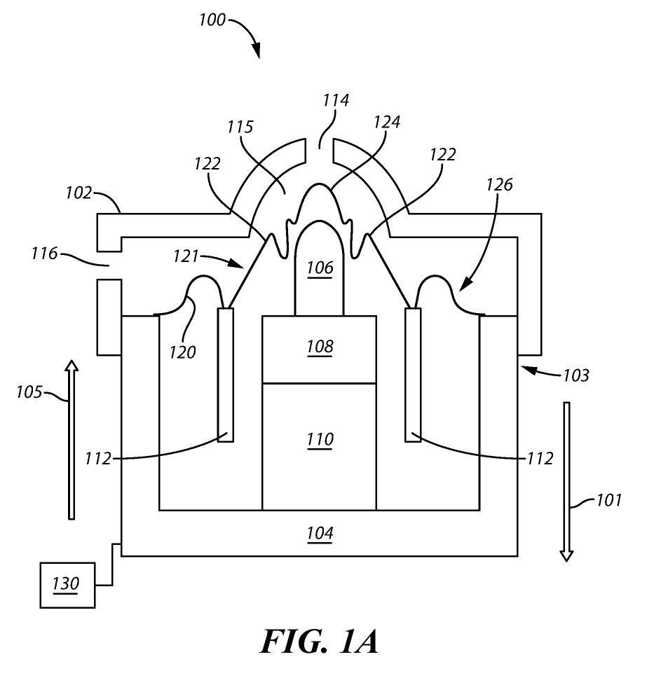

With reference to FIG. 1, an in-the-ear component 10 of an audio device, such as a hearing aid, headphone, earphone, or headset, is provided that includes an ear canal-engaging portion, such as a tip or dome 14, configured to fit into an ear canal 12 and form an airtight seal. The in-the-ear component 10 further includes an outer portion, such as a body 3, which extends outside of the ear canal 12. The body 3 supports a receiver 20 and an acoustic valve 100. A sound passage 15 extends through the in-the-ear component 10 and connects an opening 17 of the dome 14 to an opening 19 of the body 3. The sound passage 15 allows pressure to equalize between the ear canal 12 and the surrounding atmosphere. The acoustic valve 100 is positioned within the sound passage 15 so that when the acoustic valve is closed, the sound passage 15 is blocked. The acoustic valve 100 is described in more detail below. The in-the-ear component 10 also includes one or more receivers 20 and one or more sound passages 16 connecting the one or more receivers 20 to the ear canal 12. The receiver 20 converts electrical signals to sound, which then travels down the second sound passage 16 and into the ear canal 12. For example, the one or more receivers 20 may each include a balanced armature or a dynamic speaker which converts electrical signals to sound.

With reference to FIG. 1A, the acoustic valve 100 has a housing 103 that includes a grille 102 and a yoke 104. In some embodiments, the housing 103 of the acoustic valve 100 is part of the body 3 of the audio device 10. In other embodiments, the housing 103 is a separate element contained at least partially in the body 3 of the in-the-ear component 10. The grille 102 has an inlet 114, an outlet 116, and a vent or sound passage 115. The inlet 114 and outlet 116 connect to the sound passage 15 of the body 3 such that, in one form, the sound passage 115 of the acoustic valve 100 forms a portion of the sound passage 15 of the body 3. When opened, the acoustic valve 100 permits airflow through the in-the-ear component 10, bypassing the seal formed between the dome 14 and the ear canal 12. In this manner, pressure build-up within the ear canal 12 is minimized and ambient sounds can travel through the in- the-ear component 10 and into the ear canal 12.

With reference to FIG. 1A, the acoustic valve 100 further includes a movable member, such as a diaphragm 120, and a driver for moving the diaphragm 120, such as a coil 112 and a magnet 110. The acoustic valve 100 further includes a seat, such as a pole 106, and a top plate 108. The diaphragm 120 includes an outer portion 126 and a center portion 121. The diaphragm 120 can be made of a thin material, such as plastic, polyethylene terephthalate, polyetheretherketone, vinyl, or aluminum. The outer portion 126 couples the diaphragm 120 to the housing 103 and the coil 112.

The center portion 121 includes a roll portion 122 and a plug portion 124. The plug portion 124 may have a domed shape with a partially spherical upper end. The roll portion 122 may extend completely around a base of the plug portion 124 and connects the plug portion 124 to the outer portion 126 of the diaphragm 120. The roll portion 122 include one or more bends in the material of the diaphragm 120 and may have a generally S-shaped cross section as shown in FIG. 1A. The roll portion 122 is configured to have two stable configurations and snaps or oil-cans between the stable configurations in response to sufficient forces being applied to the roll portion 122.

The acoustic valve 100 is operable to selectively open and close the sound passage 115 and change the acoustic performance of the in-the-ear component 10. The acoustic valve 100 also includes an actuator that can shift the acoustic valve 100 between open and closed configurations. In one form, the actuator includes the grille 102 and the pole 106 which are used to shift the roll portion 122 of the diaphragm 120 between stable configurations, as discussed in greater detail below. As another example, the diaphragm 120 can interact with the grille 102 away from the inlet 114 and the pole 106 to shift the roll portion 122 between stable configurations.

The acoustic valve 100 may include or is coupled to a control circuit 130 that applies current to the coil 112 and creates a changing magnetic field, as shown in FIG. 1A. The magnetic field causes the coil 112 to move relative to the magnet 110. FIG. 1A shows the coil 112 and diaphragm 120 in an equilibrium position, i.e., the position of the coil 112 and the diaphragm 120 when the coil 112 is not energized. Energizing the coil 112 causes the coil 112 to move in a first direction 101 or in a second direction 105 away from the equilibrium position.

The diaphragm 120, and in particular the center portion 121 thereof, has first and second stable states wherein the roll portion 122 positions the plug portion 124 at different heights within the housing 103. With reference to FIG. 1A, the center portion 121 has a first stable state wherein the roll portion 122 positions the plug position 124 in a retracted configuration spaced from the inlet 114 so that sound can flow from the inlet 114 to the outlet 116 through the sound passage 115. Because the sound passage 115 is unobstructed, ambient noises can be heard by the user and pressure inside the ear canal 12 can equalize with the surrounding atmosphere. More specifically, ambient noises may enter through the opening 19 of the body 3, travel into the inlet 114, travel through the sound passage 115, exit the outlet 116, and travel down the sound passage 15 toward the ear drum of the user. The acoustic valve 134 is in an open configuration with the center portion 121 in the first stable state of FIG. 1A.

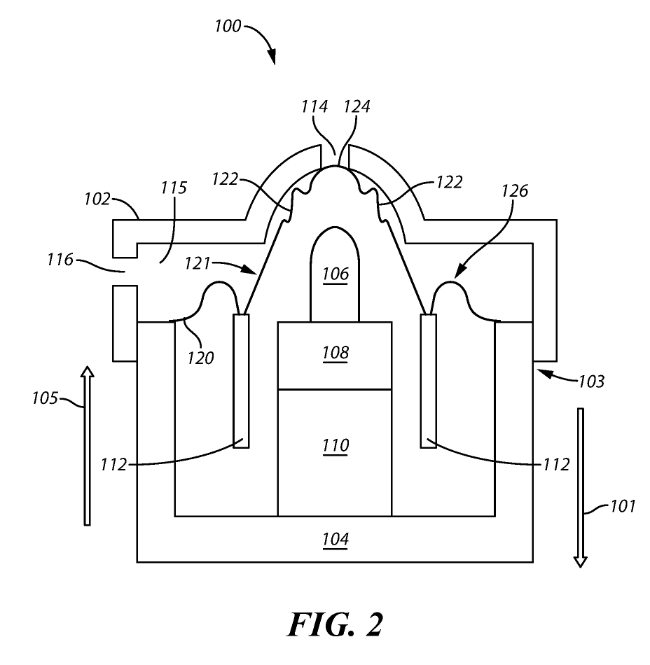

In FIG. 2, the center portion 121 of the diaphragm 120 is in the second stable state. In this state, the roll portion 122 positions the plug portion 124 against the grille 102. This causes the plug portion 124 to cover the inlet 114 and block the sound passage 115. The blocking of the sound passage 115 restricts ambient noise from entering the inlet 114, traveling through the sound passage 115, and exiting the outlet 116. This also prevents pressure inside the ear canal 12 from equalizing with the surrounding environment. The acoustic valve 100 is in a closed configuration with the center portion 121 in the second stable state. This may be preferable for listening to music or videos, especially when the music or video includes low frequency audio.

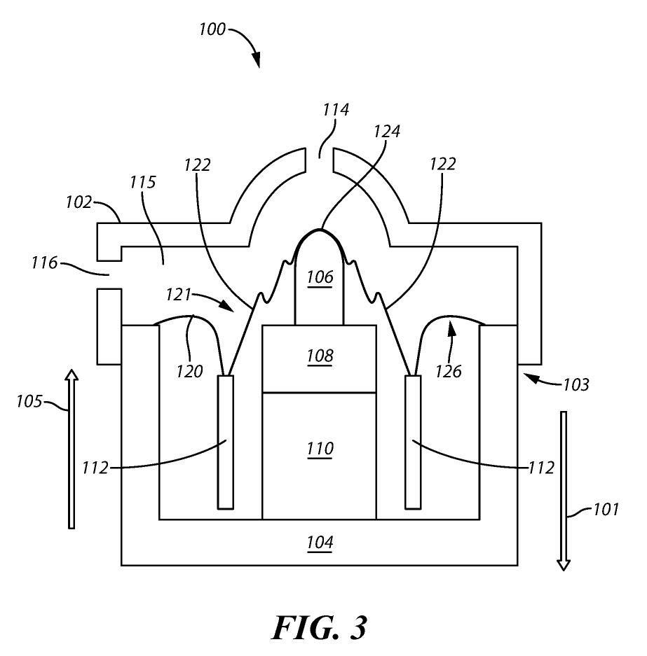

In order to transition from the first stable state, shown in FIG. 1A, to the second stable state, shown in FIG. 2, the coil 112 is moved in direction 101 which seats the plug portion 124 on the pole 106 as shown in FIG. 3. The pole 106 supports the plug portion 124 of the diaphragm 120 while the coil 112 pulls the outer portion 126 of the diaphragm 120 in the direction 101. The resulting tension in the diaphragm 120 causes the roll portion 122 to snap, or oil-can, to the second stable state wherein the plug portion 124 is in the extended configuration thereof To cause the coil 112 to pull the outer portion 126 in direction 101, the control circuit 130 sends a pulse electrical current to the coil 112 which creates a magnetic field that interacts with the magnet 110. The interacting magnetic fields of the coil 112 and the magnet 110 cause the coil 112 and diaphragm 120 connected thereto to move relative to the magnet 110 and causes the roll portion 122 to oil-can to the second stable configuration thereof

Once the control circuit 130 stops sending the pulse electrical current to the coil 112, the coil 112 returns to its equilibrium state due to the geometry of the diaphragm 120. When the coil 112 has returned to the equilibrium point, the plug portion 124 is still in the extended configuration and blocks the inlet 114, as shown in FIG. 2. The acoustic valve 100 is thereby closed and resists sound traveling from the inlet 114 to the outlet 116. Further, the center portion 121 remains in this second stable position until the control circuit 130 sends a pulse electrical current of opposite polarity, as discussed below.

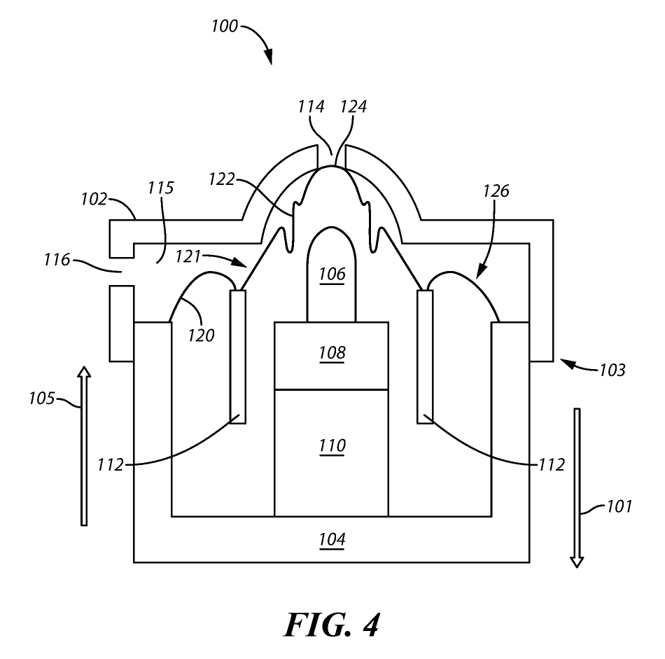

In order to transition the center portion 121 from the second stable state, shown in FIG. 2, back to the first stable state, shown in FIG. 1A, the plug portion 124 is pressed against the grille 102 to cause the roll portion 122 to oil-can back to the first stable configuration thereof as shown in FIG. 4. More specifically, the control circuit 130 energizes the coil 112 with a pulse of current having a polarity opposite to the polarity of the current being applied to the coil 112 in FIG. 3. This creates a magnetic field that interacts with the magnetic field of the magnet 110 and moves the coil 112 in direction 105 relative to the magnet 110 to drive the plug portion 124 up against the grille 102. The grille 102 resists further upward movement of the plug portion 124 beyond a predetermined position while the coil 112 continues to press the outer portion 126 of the diaphragm 120 further in direction 105. The resulting stress in the diaphragm 120 causes the roll portion 122 to oil-can back to the first stable configuration. When the current is removed, the coil 112 may return to the equilibrium point and the plug portion 124 of the diaphragm 120 is spaced apart from the inlet 114 as shown in FIG. 1A. The acoustic valve 100 is thereby opened, allowing sound to travel from the inlet 114 to the outlet 116 via the sound passage 115.

The opening and closing of the acoustic valve 100 requires little energy compared to other forms of valves, as energy is only needed to switch the center portion 121 between first and second stable states and not to sustain either state. Further, the acoustic valve 100 can switch the center portion 121 between the first and second stable states generally while the receiver 20 is producing audio so that a user may not miss any sounds during the transition. The switching between first and second stable states can be triggered by the pressing of a button on the in-the-ear component 10, flipping of a switch of the in-the-ear component 10, or by the selection of a certain mode in a control program of the acoustic device that includes the in-the-ear component 10, for example.

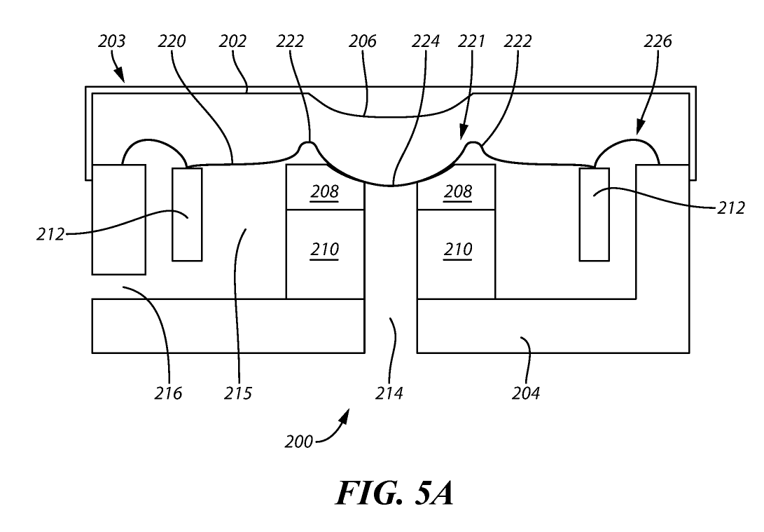

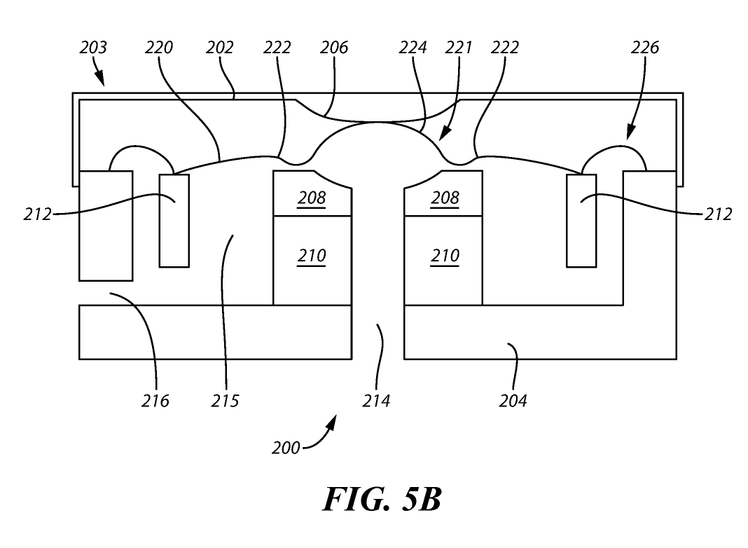

FIGS. 5A-5B show another acoustic valve 200 that is similar in many respects to the acoustic valve 100 discussed above. FIG. 5A shows the acoustic valve 200 in a closed configuration and FIG. 5B shows the acoustic valve 200 in an open configuration. The acoustic valve 200 has a housing 203 that includes a grille 202 and a yoke 204. The yoke 204 had an inlet 214 and an outlet 216 connected by a sound passage 215. In one form, the sound passage 115 of the acoustic valve 200 forms a portion of the sound passage 15 of the in-the-ear component 10. The acoustic valve 200 further includes a diaphragm 220 which is operably coupled to a coil 212. A current is applied to the coil 212 to create a magnetic field which interacts with a magnet 210 of the acoustic valve 200 and causes a portion of the diaphragm 220 to move up or down. The diaphragm has an outer portion 226, which is attached to the coil 212, and a center portion 221 that includes a plug portion 224 and a roll portion 222. The roll portion 222 has an annular shape (into and out of the page in FIG. 5A).

In the closed state of the acoustic valve 200, shown in FIG. 5A, the center portion 221 of the diaphragm 220 is in a first stable state with the roll portion 222 projecting toward the grille 202 while the plug portion 224 is projecting toward the yoke 204. The plug portion 224 makes contact with the metal plate 208 and in doing so blocks the sound passage 215.

In the open state of the acoustic valve 200, as shown in FIG. 5B, the center portion 221 of the diaphragm 220 is in a second stable state with the roll portion 222 projecting toward the yoke 204. There is a gap between the roll portion 222 and the metal plate 208 through which the sound passage 215 extends. In this configuration, sound can travel between the inlet 214 and outlet 216 and pressure can equalize across the acoustic valve.

To transition from the open state of FIG. 5B to the closed state of FIG. 5A, a current is applied to the coil 212 in order to move the center portion 221 of the diaphragm 220 toward the grille 202. The pole 206 resists movement of the plug portion 224 beyond a predetermined position while the coil 212 continues to move relative to the magnet 210, which produces stress within the diaphragm 220. This stress causes the center portion 221 to oil-can into the first stable configuration thereof shown in FIG. 5A.

To transition from the closed state of FIG. 5A to the open state of FIG. 5B, an opposite current is applied to the coil 212. This causes the coil 212 and the center portion 221 of the diaphragm 220 to move toward the yoke 204. The metal plate 208 resists movement of the plug portion 224 beyond a predetermined position while the coil 212 continues to move relative to the magnet 210, which creates stress within the diaphragm 220. The stress causes the center portion 221 to oil-can into the second stable state shown in FIG. 5B. As with the first embodiment, once the diaphragm 220 has oil-canned, the electrical pulse can be removed from the coil 212 and the center portion 221 will remain in the stable state it transitioned into.

In an alternative embodiment of the acoustic valve 200, a gap remains between the metal plate 208 and the plug portion 224 in the first stable state (shown in FIG. 5A) through which sound can pass, thus the acoustic valve 200 is in an open state. In the second stable state, the post 206 pushes down on the diaphragm 200 at the plug portion 224 such that the roll portion 222 contacts the metal plate 208, placing the acoustic valve in a closed state.

In yet another embodiment, the metal plate 208 may be replaced with a portion of the yoke 204. Alternatively, a portion of the yoke 204 could be placed between the metal plate 208 and the diaphragm 220.

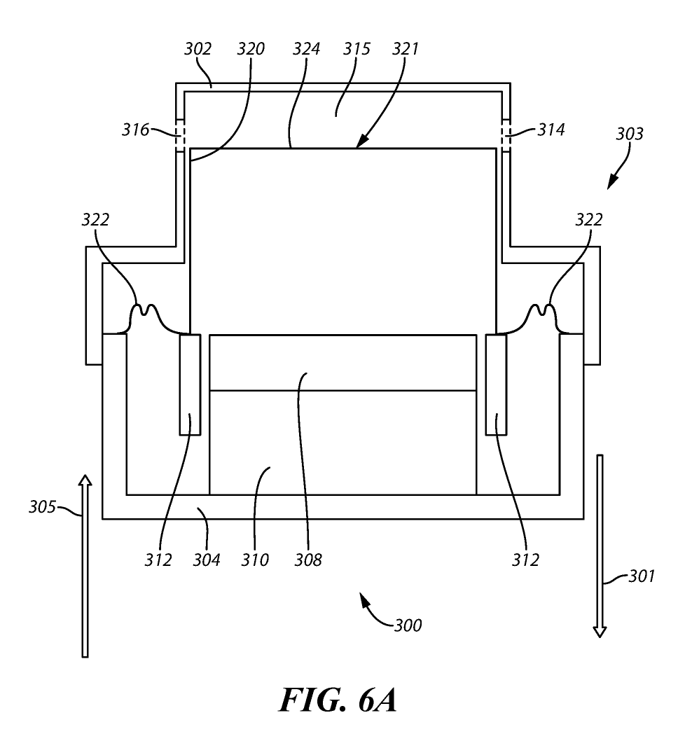

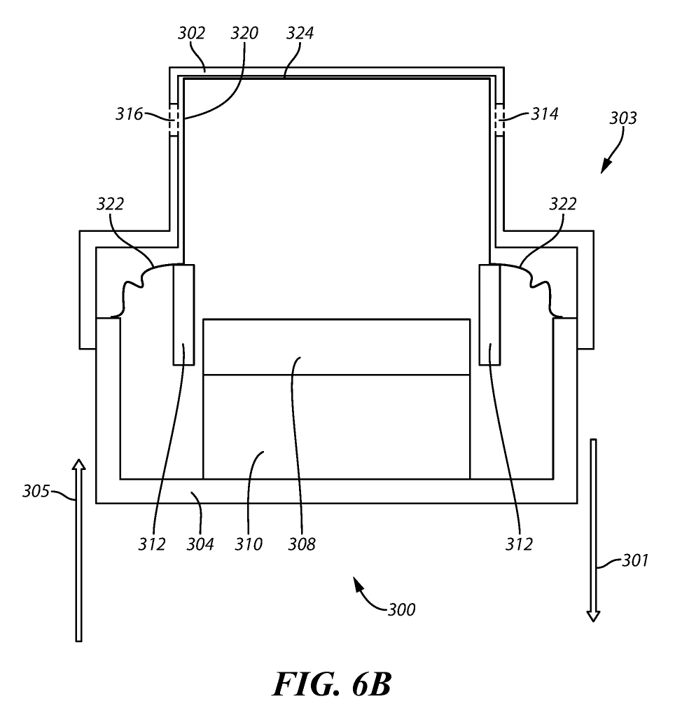

With reference to FIGS. 6A-6B, another acoustic valve 300 is provided that is similar in many respects to the acoustic valve 100. FIG. 6A shows the acoustic valve 300 in an open state and FIG. 6B shows the acoustic valve 300 in a closed state. The acoustic valve 300 comprises a housing 303 that includes a grille 302 and a yoke 304. The grille 302 had an inlet 314 and an outlet 316 attached by a sound passage 315. The inlet 314 and outlet 316 are attached to the sound passage 15 of the audio device. The acoustic valve 300 further includes a diaphragm 320 which is operably coupled to a coil 312. A current can be applied to the coil 312 to create a magnetic field that interacts with a magnetic field of a magnet 310 and moves the coil 312 and the diaphragm 320 in directions 301, 305. The diaphragm 320 has a center portion 321 that includes a plug portion 324 and a roll portion 322. The roll portion 322 is located outward from the plug portion 322 and toward an outer edge of the diaphragm 320. Specifically, the roll portion 322 is located between where the diaphragm 320 attaches to the coil 312 and where the diaphragm 320 attaches to the yoke 304.

In the open state of the acoustic valve 300, shown in FIG. 6A, the center portion 321 of the diaphragm 320 is in a first stable state with the roll portion 322 having an upside-down W-shape while the plug portion 324 is spaced apart from the grille 302. The gap between the plug portion 324 and the grille 302 permits sound to travel through the sound passage 315 extending from the inlet 314 to the outlet 316.

In the closed state of the acoustic valve 300, as shown in FIG. 6B, the center portion 321 of the diaphragm 320 is in a second stable state with the roll portion 322 having an expanded, upside-down W-shape which extends the plug portion 324 toward the grille 304. The plug portion 324 may extend closely adjacent to or contact the grille 302 when the plug portion 324 blocks the sound passage 315.

To transition the acoustic valve 300 from the closed state of FIG. 6B to the open state of FIG. 6A, a current is applied to the coil 312 to cause the center portion 321 of the diaphragm 320 to move in direction 301 toward the yoke 304. The connection between the diaphragm 320 and the yoke 304 resists movement of an outer end of the roll portion 322 beyond a predetermined position while the coil 312 continues to move in direction 301, resulting in stress in the diaphragm 320. The stress causes the roll portion 322 to oil-can into the first stable state shown in FIG. 6A.

To transition the acoustic valve 300 from the open configuration of FIG. 6A to the closed configuration of FIG. 6B, a pulse of current having an opposite polarity is applied to the coil 312. This causes the coil 312 and center portion 321 connected thereto to move in direction 305 toward the grille 302. The connection between the diaphragm 320 and the yoke 304 resists movement of the outer end of the roll portion 322 beyond a predetermined position while the coil 312 and center portion 321 continue to move in direction 305, resulting in stress in the diaphragm 320. The stress causes the roll portion 322 to oil-can into the second stable configuration shown in FIG. 6B. As with the acoustic valve 100, once the center portion 321 of the diaphragm 320 has oil-canned, the electrical pulse can be removed from the coil 312 and it will remain in the stable state it transitioned into.

In an alternative form, the acoustic valve 100 may also used to create sound. Sound is made by powering the coil 112 to vibrate the diaphragm in a manner similar to dynamic speakers.

In alternative embodiments, the coil 112 and magnet 110 can be replaced with other kinds of drivers to move the diaphragm 120. These include, but are not limited to, the drivers with moving magnets and a stationary coil, pneumatic actuators, hydraulic actuators, piezoelectric actuators, electro-mechanical actuators, or screw driven actuators.

It will be appreciated that numerous variations to the above-mentioned approaches are possible. Variations to the above approaches may, for example, include changing the shape or location of the rolls 121 and/or plug portion 124 within the diaphragm 120.

Preferred embodiments of this invention are described herein, including best mode known to the inventors for carrying out the invention. It should be understood that the illustrated embodiments are exemplary only, and should not be taken as limiting the scope of the invention.

What is claimed is:

1. An in-the-ear component comprising:
a receiver operable to produce sound;
an ear canal-engaging portion;
an outer portion;
a passage extending through the ear canal-engaging portion and the outer portion; and
an acoustic valve operable to open and close the passage.

2. The in-the-ear component of claim 1 further comprising a control circuit configured to apply an electric pulse to cause the acoustic valve to open and close the passage.

3. The in-the-ear component of claim 1 wherein the acoustic valve includes a movable diaphragm having a center portion with a first stable state and a second stable state.

4. The in-the-ear component of claim 3 wherein the movable diaphragm includes a plug portion and a roll portion supporting the plug portion, the roll portion extending the plug portion when the center portion is in the first stable state and retracting the plug portion when the center portion is in the second stable state.

5. The in-the-ear component of claim 1 wherein the acoustic valve includes a diaphragm and an actuator configured to switch the diaphragm between first and second stable states of the diaphragm.

6. The in-the-ear component of claim 5 wherein the diaphragm includes a center portion and the actuator includes a seat aligned with the center portion of the diaphragm.

7. The in-the-ear component of claim 6 wherein the acoustic valve includes a housing having an opening in communication with the passage and the actuator includes a portion of the housing adjacent the opening and aligned with the seat.

8. The in-the-ear component of claim 1 wherein the acoustic valve includes an inlet opening and an outlet opening and the passage extends through the inlet opening and the outlet opening.

9. The in-the-ear component of claim 8 wherein the acoustic valve includes a movable diaphragm and the acoustic valve closes the passage by covering one of the inlet opening and the outlet opening with a portion of the diaphragm.

10. The in-the-ear component of claim 1 wherein the ear-canal engaging portion includes a dome of resilient material to engage an ear canal.

11. An acoustic valve comprising:
a housing;
a sound passage of the housing; and
a diaphragm supported by the housing, the diaphragm having a first stable state in which the diaphragm permits sound to travel through the sound passage and a second stable state in which the diaphragm restricts sound from traveling through the sound passage.

12. The acoustic valve of claim 11 wherein the diaphragm includes an outer portion secured to the housing and a center portion movable relative to the housing, the center portion being configured to obstruct the sound passage with the diaphragm in the second stable state.

13. The acoustic valve of claim 11 wherein the diaphragm includes a plug portion configured to obstruct the sound passage and a roll portion connected to the plug portion and operable to shift the plug portion between a retracted position with the diaphragm in the first stable state and an extended position with the diaphragm in the second stable state.

14. The acoustic valve of claim 11 further comprising a driver operably coupled to a portion of the diaphragm and configured to move the portion of the diaphragm in a first direction beyond a first position which switches the diaphragm from the first stable state to the second stable state and configured to move the portion of the diaphragm in a second direction beyond a second position which switches the diaphragm from the second stable state to the first stable state.

15. A method of operating an in-the-ear component of an audio device, the method comprising:
closing an acoustic valve of the in-the-ear component to restrict sound from traveling through a passage of the in-the-ear component; and
opening the acoustic valve to permit sound to travel through the passage of the in-the- ear component.

16. The method of claim 15 wherein closing the acoustic valve includes reconfiguring a diaphragm from a first stable state to a second stable state.

17. The method of claim 16 wherein opening the acoustic valve includes reconfiguring the diaphragm from the second stable state to the first stable state.

18. The method of claim 15 wherein closing the acoustic valve includes positioning a diaphragm in the in-the-ear component to cover a through opening of the in-the-ear component.

19. The method of claim 15 wherein closing the acoustic valve includes shifting a portion of a diaphragm in a first direction against a seat of the in-the-ear component and opening the acoustic valve includes shifting the portion of the diaphragm in an opposite, second direction against a wall of the in-the-ear component.

20. The method of claim 15 wherein closing the acoustic valve and opening the acoustic valve include sending an electric signal to a driver of the in-the-ear component.
